(19) United States
(12) Patent Application Publication
(10) Pub. No.: US 2015/0266756 A1
(43) Pub. Date: Sep. 24, 2015

(54) METHODS AND APPARATUS FOR TREATING SULFIDES IN PRODUCED FLUIDS

(71) Applicant: ENERSCIENCES HOLDINGS, LLC, Lafayette, LA (US)

(72) Inventors: DAVID O. TRAHAN, LAFAYETTE, LA (US); RICHARD SAPIENZA, LAFAYETTE, LA (US); SRINIVASAN AMBATIPATI, LAFAYETTE, LA (US)

(73) Assignee: ENERSCIENCES HOLDINGS, LLC, Lafayette, LA (US)

(21) Appl. No.: 14/656,781

(22) Filed: Mar. 13, 2015

Related U.S. Application Data
(60) Provisional application No. 61/955,303, filed on Mar. 19, 2014.

(51) Int. Cl. C02F 1/68

(52) U.S. Cl. CPC C02F 1/683; C02F 1/686; C02F 2101/101

(57) ABSTRACT

The invention relates to systems and methods for treating produced water with acrolein and, in particular, with an acrolein composition or water stream that is composed of less than pure or less than substantially pure acrolein. The systems and methods are portable such that the water treatment can be conducted on-site where the water to be treated is located.

### CROSS REFERENCE TO RELATED PATENT APPLICATIONS

This patent application claims the benefit of U.S. Provisional Patent Application No. 61/955,303, entitled “Method and Apparatus for Treating Sulfides in Produced Fluids”, filed on Mar. 19, 2014, the contents of which are incorporated herein by reference.

### FIELD OF THE INVENTION

The invention generally relates to methods and apparatus for treating sulfides in produced fluids, such as, a body, volume or stream of water and, in particular, the invention includes contacting the produced fluids with acrolein and/or acetal.

### BACKGROUND OF THE INVENTION

Hydrogen sulfide is a corrosive, toxic and lethal gas found, e.g., dissolved in or dispersed in, oilfield produced fluids. Oil and gas operators typically use several different commercially available chemical products and known processes, to reduce and remove hydrogen sulfide and iron sulfide (“sulfides”) from water produced from oil and gas wells or water sourced from surface impoundments. Some of these processes rely on aeration or the addition of oxidizing agents and others rely on the application of amine-based chemical additives, which can be injected continuously or used in fluid contact batch towers. The toxicity and handling characteristics of these chemicals can range from mild to severe.

It is known that monomeric acrolein (2-propenal) is effective at reducing and removing hydrogen sulfide and iron sulfide from oil and gas well produced fluids. The use of acrolein to control hydrogen sulfide in water and oil fluids begin in the 1960's and is well known. It is also a very effective biocide in the treatment of water by suppressing the growth of unwanted bacteria, algae and aquatic vegetation. In oilfield applications, acrolein is used to control sulfate-reducing bacteria in oil and gas production.

Further, it is known to use acrolein to disinfect ballast water on ships. An advantage of adding acrolein is the sustained effect particularly against larvae of zebra mussels. Since acrolein disintegrates after a short time, no new burdening of the marine port basin by this biocide is encountered when discharging ballast water into waterways and confined water areas. It has been found that the transfer of bacteria, algae, zebra mussels and other organisms of the zooplankton from one marine port to another, can be suppressed by adding 1 to 15 ppm of acrolein to the ballast water. However, the challenges in handling and applying acrolein in such applications has made the widespread use of the product difficult.

Acrolein is very dangerous to handle and apply. Acrolein can irritate the skin and mucous membranes and is a strong, pungent, lachrymator. Further, acrolein is easily flammable with a flash point of negative 29° F. causing potential problems with handling in warmer or hotter climate zones. Furthermore, there is a danger of explosive polymerization reactions if the acrolein becomes contaminated with impurities. In addition, the presence of by-products in acrolein poses numerous problems in separation of acrolein. Even in its stable form such as an acetal, acrolein has a limited shelf life. Therefore, handling precautions in the field typically need to be highly controlled. Transport of the chemical over the highway or by rail is a dangerous process and is highly regulated by local, state and federal authorities. Acrolein is an aldehyde, which is chemically referred to as “acrylic aldehyde” or “2-propenal.” Acrolein is a three-carbon vinyl aldehyde that is a highly reactive due to the conjugation of the carbon/carbon double bond with the carbonyl bond of the aldehyde group. These conjugated double bonds leave the acrolein molecule in an elevated energy state, thus making the acrolein molecule highly reactive. Its use as a hydrogen sulfide remover results in the formation of water-soluble irreversible reaction products.

As a chemical, acrolein is an intermediate chemical produced in the production of acrylic acid and its esters.

Historically, the treatment of water with acrolein has involved using a pressure rated transport tank, applying a positive pressure using a nitrogen or other inert gas on the storage tank, directing the outflow of acrolein to an open water channel or to a suction of a pressure pump for injection into a higher pressure water vessel or water line.

In addition to being used as a hydrogen sulfide scavenger, it is known to use acrolein as an aquatic herbicide in irrigation canals, as a biocide in oil field water flood applications and to dissolve iron sulfide deposits in operating equipment and transfer pipelines. Acrolein has sometimes been referred to in industry as an all-in-one chemical solution to assist in resolving these problems. The acrolein undergoes degradation in water after relatively short periods of time. The acrolein is no longer active as a biocide at the point of irrigation of crops. Furthermore, it is degraded into decomposition products that do not harm the physiology of plants.

The capability of acrolein to scavenge hydrogen sulfide is affected by the water parameters specific for any water handling system. The water parameters impact the length of time that acrolein remains potent as a sulfide scavenger, the speed of the acrolein scavenging process, and the degree of the scavenging efficiency. Some factors that make up water parameters include pH, amount and types of ions present, and temperature. It has been shown that the most favorable pH for scavenging sulfide with acrolein is between 6 and 8. The ability of acrolein to remove hydrogen sulfide depends on how much sulfide is present and how much acrolein is used. Field data indicates, in general, a higher initial concentration of acrolein results in greater hydrogen sulfide removal. The data suggests a higher acrolein-to-sulfide ratio produces better scavenging results. Typically, a 2:1 (molar ratio) acrolein to sulfide molar is used. For example, 1.0 ppm of hydrogen sulfide consumes approximately 4 ppm acrolein, as shown in FIG. 1. In the field, treating ratios up to 5:1 acrolein to sulfide molar ratio are used to treat fluid systems containing hydrogen sulfide. The range of treatment may be caused by the presence of iron sulfide particles in the fluid system, which consumes a portion of the acrolein. As above-mentioned, acrolein is also known to dissolve iron sulfide or other metallic sulfide particles from within fluid handling systems. With iron sulfide (chemical compounds of iron and sulfur with a wide range of stoichiometric formulae and different crystalline structures), acrolein can dissolve these solids and follows the same reaction as described above and as shown in FIG. 2.

Typical acrolein treatment programs involve introducing a batch or extended batch of acrolein into fluid systems. Continuous programs, however, have proven to be more effective at scavenging hydrogen sulfide from fluid systems. In some cases, batch methods are the only methods employed because of the dangerous nature of the acrolein in the field with operators wanting to minimize their risk of spill or harm to workers. Therefore, operators perform a regular schedule of batch or extended batch treatments to introduce sufficient acrolein into a system to effect a satisfactory treatment.

As described above, acrolein involves highly reactive chemistry that provides effective treatment for bacteria, rapid scavenging of hydrogen sulfide, dissolution of iron sulfide, and as an aquatic herbicide. One factor supporting the continued use of acrolein notwithstanding the extreme handling precautions is its positive environmental profile. Acrolein hydrolyzes in water to form β-hydroxypropenal, a highly biodegradable water-soluble degradation product. With contributing factors such as elevated temperature, salinity, and presence of organic matter, acrolein has been shown to have a half-life of 8 to 24 hours in typical water systems that lack the presence of hydrogen sulfide. This is a relatively short half-life compared with other, more environmentally persistent chemicals and biocides, offering a favorable environmental profile for acrolein. The presence of hydrogen sulfide and other reactants within the normal oilfield produced fluids will only hasten the degradation of acrolein itself.

Acrolein is a liquid hydrocarbon, but exhibits the unique property of also being soluble in water. This dual solubility in oil and water and its high degree of reactivity with bacteria and sulfides enable acrolein to maintain high water quality for water-injection systems, as well as for water discharged overboard in offshore applications.

Acrolein is delivered to the field in essentially neat form, e.g., on average a minimum of 95% activity. This provides operators with a considerable treatment supply, however, it puts a significant concentration of toxic chemical on location. Acrolein is supplied in specialized containers designed to minimize the potential release from transfers between tanks and between tanks and fluid systems to be treated. The acrolein tanks are dedicated containers, which are maintained under a blanket of inert nitrogen to exclude oxygen ingress and to enhance the product shelf life. Using low nitrogen pressure, the chemical is transferred from the container through an internally mounted dip tube into a closed-system chemical manifold. From the manifold, the product can be either applied directly into a low pressure production system or directed to the suction of a diaphragm chemical pump for application to higher pressures exceeding the pressure allowed in the chemical container. Significant training is needed for acrolein service providers in the design of safe chemical transport and transfer operations. Operators must follow strict operating procedures, along with using closed-system application equipment, and redundant safety devices to prevent chemical exposure to nearby workers. Applications are performed by trained and certified personnel who have completed a specific competency evaluation under field conditions. These procedures are site-specific, including process hazard analysis, operating procedures, employee and contractor training, emergency planning and response procedures.

Apart from its activity, acrolein has an advantage over other biocides and sulfide scavengers in that it undergoes degradation in water after a relatively short time.

Acrolein, of the formula H₂C+CH—CHO, is a simple, unsaturated aldehyde most often prepared industrially by oxidation of propene. It is also known to form acrolein from glycerol. Various conventional preparation/manufacturing processes are known, such as, an exothermic double-dehydration process, as shown in FIG. 3. Propene, also known as propylene or methyl ethylene, is an unsaturated organic compound having a chemical formula of C₃H₆. At room temperature and atmospheric pressure, propene is in the form of a gas.

Glycerol is also a by-product of biodiesel synthesis from vegetable oil and animal fat (triglycerides), and though there is only a small amount of glycerol per ton of biodiesel, e.g., a 1:10 ratio, the large tonnage of biodiesel for motor fuels means a large supply of glycerol is available for chemical synthesis.

Another important use of acrolein is the synthesis of D,L-methionine used as an essential amino acid for animal feeding, and which has few, if any, natural sources.

There have been numerous studies conducted on the synthesis of acrolein by dehydration of glycerol. For example, glycerol can be obtained in a proportion of 100 kg per ton of biodiesel synthesized by trans-esterification of vegetable oils. However, the dehydration of glycerol to acrolein and the reaction is usually accompanied by high boiling compounds, and the production of tar compounds along with rapid deactivation of the catalyst. Reactive distillation of acrolein is needed to quickly separate it from the reaction system to preclude any side reaction. The glycerol of a raw material feed may contain 0 to 95% by weight of inactive condensable substances, such as, water. A solvent or the like may also exist, which in not involved in the reaction. The concentration of the glycerol of the raw material is preferably 5 to 100% by weight. The influence of the conversion of a reactant to tar or carbon particles due to the thermal decomposition reaction, which is a side reaction, becomes significant and, as such, the use of the highly pure feeds limits the raw material flexibility in raw material procurement. Due to such problems, it is considered difficult to commercialize the production of acrolein from a renewable starting material. Thus, the impurities present may be a factor in greatly reducing the field of application of the acrolein produced by the dehydration of glycerol.

In U.S. Pat. No. 7,396,962, the dehydration of glycerol is performed in the presence of molecular oxygen. The reaction is performed in the liquid phase or in the gas phase in the presence of a solid catalyst. The addition of oxygen makes it possible to obtain good glycerol conversion by inhibiting the deactivation of the catalyst and the formation of by-products.

In U.S. Pat. No. 2,558,520, the dehydration reaction is performed in the gas/liquid phase in the presence of diatomaceous earths impregnated with phosphoric acid salts, suspended in an aromatic solvent. A degree of conversion of the glycerol into acrolein of 72.3% is obtained under these conditions.

U.S. Pat. No. 5,387,720 describes a process for producing acrolein by dehydration of glycerol, in a liquid phase or in the gas phase over acidic solid catalyst defined by their Hammett acidity. The catalyst has Hammett acidity of less than +2 and preferably less than −3. According to the patent, an aqueous solution comprising 10% to 50% of glycerol is used, and the process is performed at temperatures between 180° C. and 340° C. in the liquid phase and, between 250° C. and 340° C. in the gas phase. The gas-phase reaction is described as preferable since it enables conversion of the glycerol near 100%, which leads to an aqueous acrolein solution containing side products. A proportion of about 10% of the glycerol is converted into hydroxypropanone, which is present as a major by-product in the acrolein solution. The acrolein is recovered and purified by fractional condensation or distillation.

The commercial dehydration of glycerol to acrolein is generally accompanied by side reactions leading to formation of by-products, such as, hydroxypropanone, propanaldehyde, acetaldehyde, acetone, adducts of acrolein with glycerol, glycerol polycondensation products, cyclic glycerol ethers, and the like, as well as phenol and polyaromatic compounds, which are the cause of the formation of coke on the catalyst. The formation of coke on the catalyst leads to a reduction in yield and a reduction in the selectivity towards acrolein.

Accordingly, known processes for conducting the catalytic dehydration of glycerol to produce acrolein exhibit significant limitations that are unacceptable for industrial viability. The techniques used to increase performance result in significant losses in acrolein production output or high capital costs. Similar obstacles and disadvantages are also encountered in other fields of application and thus, there is a desire in the art to develop systems and methods for producing acrolein that result in high yields while minimizing the capital and operational costs associated therewith. Further, in view of the risks in handling acrolein, there is a need for a new method for treating water using acrolein wherein the handling of the acrolein is safer and less dangerous to workers.

### SUMMARY OF THE INVENTION

It has been surprisingly found that an impure acrolein stream can be utilized in applications where pure acrolein typically has been used. Therefore, in order to solve the above-described problems, an object of the present invention is to provide an acrolein-containing stream containing impurities, such as, byproducts, un-reactants and catalyst to treat water as a biocide, herbicide or sulfide scavenger. This process precludes the need for transport and onsite application of pure acrolein or its acetal. In accordance with the invention, acrolein and/or acrolein acetal is produced at the site of application or usage, e.g., on-site, from a starting material, e.g., raw material, such as, a renewable material, and preferably, by the dehydration of glycerol. The method and water treating device in accordance with the invention are simple, reliable, transportable and capable of being operated by equipment operators with minimal training

Further, it is an object of the invention to provide a device that can be easily installed and can treat water with acrolein for long periods of operation without problems being encountered and/or pre-mixtures having to be produced.

In one aspect, the invention provides an on-site method of treating a volume, stream or body of water. The method includes producing an acrolein-containing stream having a concentration of acrolein that is less than pure or substantially pure acrolein, wherein said stream is produced on-site and outside of the volume, stream or the body of water, and introducing the acrolein-containing stream into the volume, stream or the body of water. The acrolein-containing stream is effective to reduce or remove sulfide therefrom.

The acrolein-containing stream can be derived from a process selected from the group consisting of catalytic oxidation and catalytic glycerol dehydration.

The acrolein-containing stream can include materials selected from the group consisting of water, oxygen, catalyst, by-products and mixtures thereof. The by-products can include materials selected from the group consisting of hydroxypropanone, acetaldehyde, acetone, addition products of acrolein to glycerol, polycondensation products of glycerol, cyclic glycerol ethers, hydroxypropenal, phenol, polyaromatic compounds, propylene, acrylic acid, carbon dioxide, nitrogen, helium, argon, propane and mixtures thereof.

In another aspect, the invention provides a method for treating a volume, stream or body of water. The method includes providing a water feed, providing a glycerin feed, mixing the water feed and glycerin feed to produce a water-glycerin solution, heating the water-glycerin mixture to produce a water-glycerin vapor, reacting the water-glycerin vapor with catalyst in a reactor to produce a glycerol stream, and introducing the glycerol stream into the water to be treated.

The glycerol is effective to generate acrolein when in contact with the water to be treated.

The reaction can be a fixed-bed catalyst reactor.

In certain embodiments, the glycerin is derived from vegetable oil or animal fat.

In another aspect, the invention provides a portable system for treating a volume of water. The system includes a feed mechanism for supplying glycerin, a feed mechanism for supplying water, a vessel for receiving and mixing the glycerin and water to form a glycerin/water blend, a heating system to vaporize the glycerin/water blend to form a glycerin/water vapor stream, a reactor to convert the glycerin/water vapor stream into an acetal-containing material, wherein said reactor is positioned directly or nearly directly upstream of the volume of water to be treated, a side stream containing water from the volume of water to be treated, and a delivery mechanism to introduce the acetal-containing material into the side stream to generate acrolein. The water with the acrolein in the side stream flows into the volume of water to be treated.

The reactor can be a fixed-bed catalyst reactor.

The water to be treated can be produced water from an oil field or gas field. The water to be treated can contain sulfide.

### BRIEF DESCRIPTION OF THE DRAWINGS

A full understanding of the invention can be gained from the following description of the preferred embodiments when read in conjunction with the accompanying drawings, in which:

FIG. 1 is a schematic showing the reaction of acrolein and hydrogen sulfide, in accordance with the prior art;

FIG. 2 is a schematic showing the reaction of acrolein and iron sulfide, in accordance with the prior art;

FIG. 3 is a schematic showing the formation of acrolein from glycerol in a dehydration process, in accordance with the prior art;

FIG. 4 is a schematic showing the main and side reactions of glycerin to form acrolein, in accordance with certain embodiments of the invention;

FIG. 5 is a schematic showing a process with reactant vapor eduction, in accordance with certain embodiments of the invention;

FIG. 6 is a schematic showing a process with reactant vapor condensed, in accordance with certain embodiments of the invention; and

FIGS. 7 and 8 are plots showing acrolein productivity vs. time on stream, in accordance with certain embodiments of the invention.

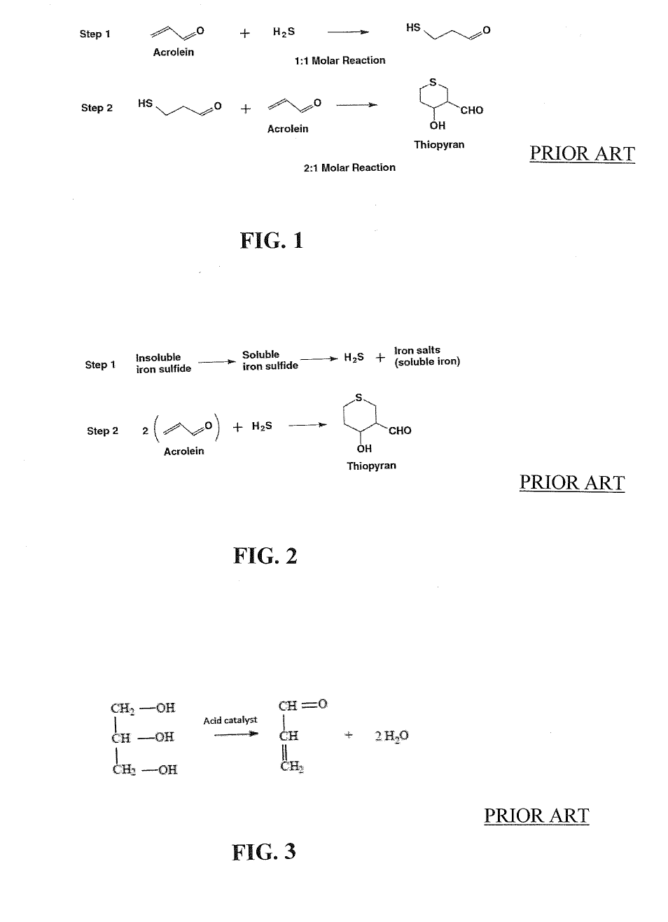

### DETAILED DESCRIPTION OF THE INVENTION

The systems and methods according to the invention relate to treating bodies of water or other fluids with acrolein, wherein acrolein is formed on-site, but outside the system of water or fluid to be treated. The invention relates to the methods of producing acrolein, obtaining an impure acrolein reaction phase and then introducing that acrolein-residual phase immediately and directly into the acrolein reaction region, e.g., the water or fluid to be treated. The inventive systems and methods can be used to treat, with acrolein, bodies of water or water flowing in a pipe or vessel.

The commercial supply of high purity acrolein to an acrolein consuming process is one of the more costly features of such processes and considerable savings can be realized if low purity acrolein streams can be made available from other operations. In the systems and methods according to the invention, at least a portion of the needed acrolein can be obtained inexpensively from a low purity stream of glycerol which would normally not be useable for the purpose of treating fluids that contain sulfide, such as, hydrogen sulfide and/or iron sulfide in oil field or gas field produced fluids, or microbes, or bacteria, such as, algae, from ocean or marine water.

As above-described herein, it is known to treat a volume or body or stream of water with acrolein, wherein pure or substantially pure acrolein is packaged/contained and then transported to the site of the volume, body or stream of water. When on-site, the acrolein is removed or released from its package/container and introduced into the water to be treated. Packaging/containing and handling pure or substantially pure acrolein can be labor and cost intensive due to the volatile nature of the material. Since there are significant environmental and safety concerns associated with the transport and handling of pure or substantially pure acrolein, the invention provides improved systems and methods for treating a volume or body or stream of water with acrolein, which does not include the need to transport or handle pure or substantially pure acrolein. In accordance with the invention, the systems and methods of treatment can be initiated and subsequently completed on-site, i.e., at or near the location of the volume or body or stream of water. In this regard, the systems of the invention are substantially compact and portable. Further, the systems and methods of the invention include the generation and use of a treatment composition, e.g., stream, which uses as its starting material an acrolein-containing or acrolein-rich treatment stream. That is, the treatment composition not pure or substantially pure acrolein. The treatment composition can include a variety of materials and is typically composed of acetal, such as, but not limited to, glycerol. A wide variety of suitable acetal materials are known in the art and discussed in more detail herein.

The acrolein-rich composition, e.g., stream, for use in the invention may be produced by any conventional technique known by those of ordinary skill in the art. Generally, acrolein synthesis methods can be divided into three categories: condensation (formaldehyde, acetaldehyde vapor condensation, aldol condensation); oxidation (oxidation of propylene, propane oxidation and allyl alcohol oxidation); and the decomposition method (propenyl ether pyrolysis).

An acrolein-rich stream in accordance with the invention can be the product stream of a propylene (or other non-petroleum based sources of hydrocarbons) catalytic oxidation process, or the product stream of glycerol dehydration in liquid or gas phase, preferably, gas phase, or in a stream of hydroxypropenal dehydration. Additionally, any conventional raw material feed may be used to produce acrolein and stably synthesized acrolein in the form of acetals, provided the acrolein and/or its acetals are present in the treatment stream in a useful, e.g., effective, concentration, preferably, the yield from a catalytic glycerol dehydration reaction.

Generally, the acrolein-rich stream results in a gas mixture that is suitable for use in the systems and methods of the invention without additional processing steps, such as, the removal of amounts of water, which could result in costly losses of acrolein. In addition, a portion of the heavy impurities formed during the dehydration of the glycerol are not removed to avoid costly purification operations.

In certain embodiments, the invention includes catalytic dehydration of glycerol to acrolein, which is mainly divided into homogenous and heterogenous systems. To avoid known commercial production and transportation/handling problems associated with acrolein, the invention is capable of utilizing an aqueous stream of glycerol, e.g., substandard glycerol, vaporized into steam and, directed through and over acid-based catalyst to form glycerol acetal. The vaporized glycerol acetal is then either condensed as a mixed steam of reaction products and unreacted glycerin or directed into a water quench. The condensed mixed stream is used in water treating, without the risk of polymerization associated with concentrated acrolein. Upon mixing of the acetal and produced water or contained water, e.g., water to be treated, at sufficiently low pH, the glycerol is released from the acetal through hydrolysis creating a dilute product capable of aggressively scavenging sulfides from the produced water and serving as an aquatic herbicide in ponds and irrigation systems.

The invention is generally described as a micro-catalytic process utilizing glycerol as a feedstock, a heating system to vaporize glycerin and water, and an acid catalyst packed-bed reactor to convert the vaporized glycerol/water stream into acrolein-like chemicals at the point, or very near the point, of injection into the water system to be treated. The acrolein-like materials are impure or incompletely reacted feed materials, which provide effective treatment for the removal of hydrogen sulfide, iron sulfide, bacteria and aquatic vegetation. Further, the inventive systems and processes allow operators to avoid known dangers and disadvantages associated with handling acrolein in the field. Systems and processes in accordance with certain embodiments of the invention are commercially available under the trade names AGROGEN™ or ACROSHOT™.

Thus, in general, the processes according to the invention include a liquid to gas-phase method, which precludes the need to employ pure acrolein in the field. The safety and simplicity of the process design avoids handling and transporting potentially harmful or lethal concentrations of acrolein by using a glycerol/water blend as the feedstock.

Heterogenous catalysts are known in the art and include solid superacid, zeolite support heteropoly acids. Heterogenous catalyst have good catalytic activity, but catalyst life and stability are factors that restrict its development and use. Homogenous catalysts are also known in the art and may be selected from inorganic acids and inorganic acid salts, for use in the invention. For each catalyst there is a corresponding optimum temperature or temperature range that is associated with, or provides for, high conversion of acrolein. The acrolein-rich stream in the process according to the invention can contain water, oxygen, or the homogenous catalyst and subsequently by-products such as hydroxypropanone, acetaldehyde, acetone, addition products of acrolein to glycerol, polycondensation products of glycerol, cyclic glycerol ethers, hydroxypropenal, phenol and polyaromatic compounds, propylene, acrylic acid, and inert gases such as carbon dioxide, nitrogen, helium, argon, and propane. The nature of the by-products and the composition of the acrolein-rich stream depend on the raw material used to produce the acrolein. Based on the raw material and reaction selected, a particular reaction mixture, e.g., treatment stream is produced, which is introduced into the water to be treated.

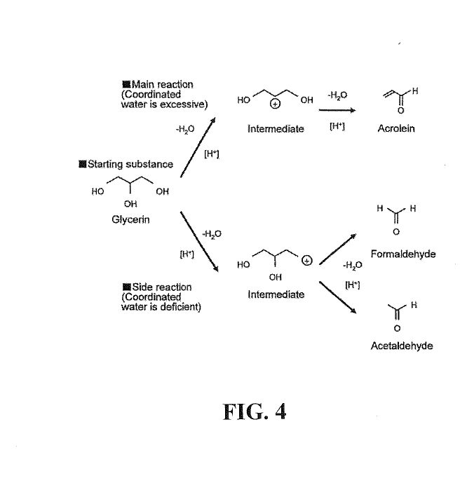

In general, the systems and processes of the invention include the following steps. Glycerin and water are mixed and heated to a temperature of about 300° C. A resultant glycerol/water vapor stream is directed into a catalytic packed bed reactor containing an acid catalyst material. In the packed bed reactor the glycerin/water vapor stream reacts to form acetal, which is a precursor to forming acrolein. The acid catalyst packed bed is immediately upstream, e.g., in close proximity, of the water/fluid system to be treated or is directly upstream, e.g., in close proximity, of a side stream of the water/fluid system to be treated. The acetal can be an alcohol on an aldehyde, such as, glycerol on an aldehyde. The reactor discharges the process stream directly into a water quench stream having a temperature about 50° C., wherein the water quench stream is a side stream of the water to be treated. The acetal in the water reacts with the acidic nature of the water to reduce the alkalinity and release the glycerol. This intermediate step is a unique approach to treating process fluids to remove hydrogen sulfide or perform the other actions of acrolein. The water terminates the reaction and avoids further homogenous oxidation reactions, as shown in FIG. 4. In general, the acetal reacts with the acidic nature of the produced water, e.g., water to be treated, to release glycerol and generate acrolein.

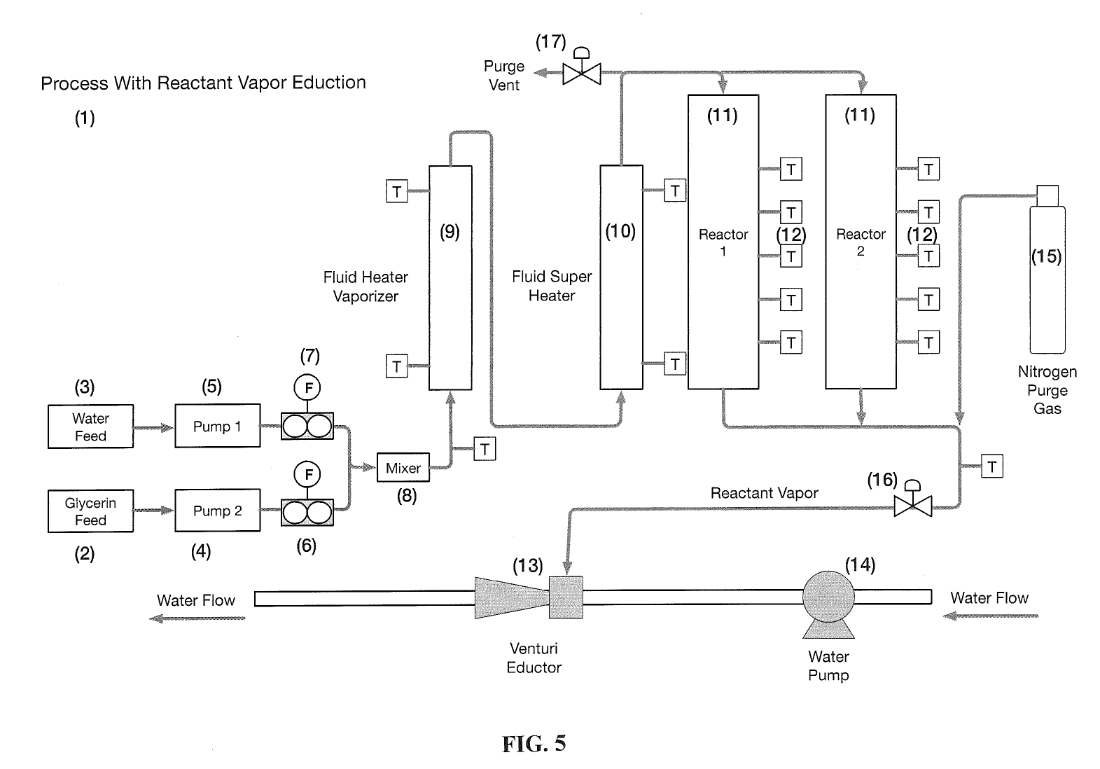

FIG. 5 is a schematic showing a water treatment system and process in accordance with certain embodiments of the invention. As shown in FIG. 5, a production system 1 includes one or more storage tanks for glycerin feed 2 and one or more tanks for potable water feed 3. The glycerin and water are directed via a pipe or conduit to independently feed the suction of positive displacement pumps 4 and 5, respectively. The fluid stream of glycerin and water are metered independently using flow measurement instruments 6 and 7, respectively, and the two streams of liquid are combined or commingled into a single line or conduit and directed through an in-line mixer or static mixing device 8. The glycerin-water solution is directed via a pipe or conduit into a fluid heater or thermal vaporizer 9 where it is heated to a range of about 200° C. (392° F.) to about 250° C. (482° F.), creating a saturated stream of glycerin water vapor at the operating pressure between about 1 atmosphere and about 2 atmosphere, before being directed via a pipe or conduit into a fluid superheater 10 where the fluid stream is heated to about 280° C. (536° F.) to about 320° C. (608° F.). The super-heated glycerin-water vapor leaving the superheater 10 is directed via a pipe or conduit into the top of a reactor vessel 11 that can be a fixed bed catalyst reactor. There may be multiple reactor vessels arranged, e.g., piped, in parallel to allow for longer process run times by diverting flow of the glycerin-water vapor to additional reactor vessels. The fixed bed reactor vessels are fitted with one or more thermocouple temperature measurement devices 12 to record and report the temperature within the reactor vessel in a timely manner. The reactor arrangement allows for flow to be directed through one or more reactor vessels in parallel or in sequence. The reactant vapor is discharged from the bottom of the reactor via a pipe or conduit and is directed into a vapor-liquid eductor 13 positioned downstream of the reactor. The vapor-liquid eductor 13 uses the motive force of a flow of water through the eductor. The flow through the eductor creates a negative pressure zone within the eductor body drawing in the vapor into the flow of water. The flow of water is provided by water pump 14 drawing water from a water line, water reservoir, water tank or other source of water. The vapor-liquid eductor also provides a means whereby the reactant vapor mixes with water to facilitate the quench of hot reactant vapors with a water stream. The concentration of acrolein in the water downstream of vapor-liquid eductor is measured by fluid samples.

In an event, when a shutdown of the process is required, the reactor vessels are purged with a nitrogen gas 15 directed into the downstream line of the reactor vessels via a conduit or piping. A normally open control valve 16 is actuated closing off the flow downstream directing nitrogen toward reactor vessels. The nitrogen purge gas exits the reactors at the top of the reactor vessel and is directed via conduit or piping to a nitrogen purge gas vent 17 which is fitted with a normally open control valve which is actuated at the same time as the control valve 16.

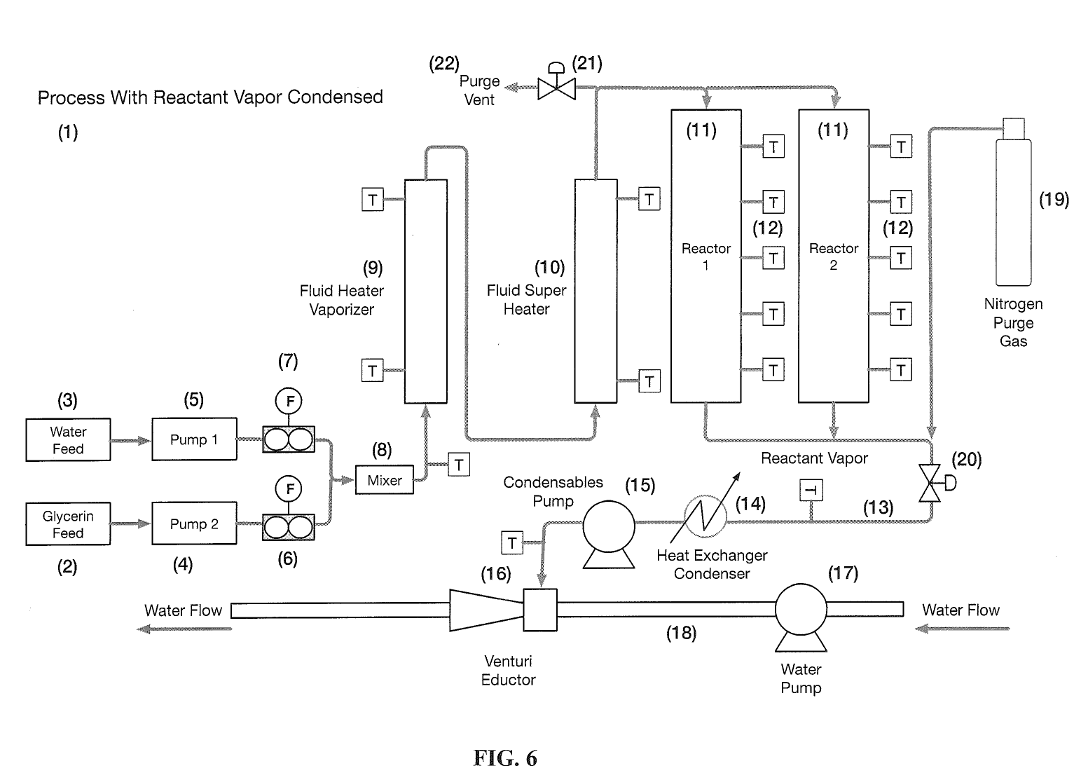

FIG. 6 is a schematic showing a water treatment system and process in accordance with certain other embodiments of the invention. As shown in FIG. 6, a production system 1 includes one or more storage tanks for glycerin feed 2 and one or more tanks for potable water supply 3. The glycerin and water are directed via a pipe or conduit to independently feed the suction of positive displacement pumps 4 and 5, respectively. The fluid stream of glycerin and water are metered independently using flow measurement instruments 6 and 7, respectively, and the two streams of liquid are combined or commingled into a single line or conduit and directed through an in-line mixer or static mixing device 8. The glycerin-water solution is directed via a pipe or conduit into a fluid heater or thermal vaporizer 9 where it is heated to a range from about 200° C. (392° F.) to about 250° C. (482° F.), creating a saturated stream of glycerin water vapor at the operating pressure between about 1 atmosphere and about 2 atmosphere, before being directed via a pipe or conduit into a fluid superheater 10 where the fluid stream is heated to about 280° C. (536° F.) to about 320° C. (608° F.). The super-heated glycerin-water vapor leaving the superheater 10 is directed via a pipe or conduit into the top of a reactor vessel 11 that can be a fixed bed catalyst reactor. There may be multiple reactor vessels piped in parallel to allow for longer process run times by diverting flow of glycerin water vapor to additional reactor vessels. The fixed bed reactor vessels are fitted with one or more thermocouple temperature measurement devices 12 to record and report the temperature within the reactor vessel in a timely manner. The reactor arrangement allows for flow to be directed through one or more reactor vessels in parallel or in sequence. The reactant vapor is discharged from the bottom of the reactor via a pipe or conduit 13 and is directed into a heat exchanger 14 where the reactant vapor temperature is lowered to approximately 55° C. (130° F.), condensing the reactant vapor into a liquid. The condensed reactant liquid is pumped by a liquid pump 15 into a port on the vapor-liquid eductor 16 positioned downstream of the reactor. The vapor-liquid eductor 16 uses the motive force of a flow of water flowing through the eductor 16. The flow through the eductor 16 creates a negative pressure zone within the body of the eductor 16, drawing in the vapor into the flow of water. The flow of water is provided by water pump 17 drawing water from a water line, water reservoir, water tank or other source of water pumping the water via a conduit or pipe 18 into the vapor-liquid eductor 16. The vapor-liquid eductor 16 also provides a means whereby uncondensed reactant vapor and condensed reactant vapor liquids mix with water. The concentration of acrolein in the water downstream of vapor-liquid eductor 16 is measured by fluid samples. In an event, when shut down of the process is required, the reactor vessels are purged with a nitrogen gas 19 directed into the downstream line of the reactor vessels via a conduit or piping. A normally open control valve 20 is actuated closing off the flow downstream directing nitrogen toward reactor vessels. The nitrogen purge gas exits the reactors at the top of the reactor vessel and is directed via conduit or piping to a nitrogen purge gas vent 22 which is fitted with a normally open control valve which is actuated at the same time as control valve 21.

In accordance with the invention, the vapor stream exiting the reactor vessel 11 is composed primarily of a precursor to acrolein, e.g., acetal, and further includes unreacted glycerin and water vapor. The acetal precursor is an organic compound formed by condensation of the reactor vapor effluent and has a general formula of R¹CH(OR²)₂, wherein R¹ and R² are the same or different and each is alkyl. The vapor stream exiting the reactor vessel 11 does not include acrolein. The vapor stream then enters the vapor-liquid eductor 16, e.g., venturi eductor, wherein it is contacted with a water stream, which typically is at ambient temperature. However, the temperature can vary and therefore, can be higher or lower than ambient depending on the source of the water. This water stream provides a motive force to create a suction pressure on the reactor vapor. The vapor mixes with the water and is quenched, transitioning from a vapor to a liquid, and converting the vaporized acetal into dilute acrolein. The conversion efficiency to acrolein can vary. In certain embodiments, up to about 60% or up to 30% or from about 30% to about 60% of the glycerin vapor is converted into acrolein. Further, the amount or concentration of glycerin introduced into the system, e.g., feed, can vary and can impact the amount of acrolein produced. For example, the concentration of glycerin feed can be from about 1% to about 80% by weight based on total weight of the glycerin and water feeds introduced into the system. In certain embodiments, glycerin is present in an amount of about 40% based on total weight of the glycerin-water feed.

In an embodiment, wherein the glycerin-water feed includes about 40% by weight glycerin, about 30% of the glycerin is converted into acrolein following quench in the water stream of the vapor-liquid eductor 16. In this embodiment, the resulting acrolein formed is about 12% of the water stream.

In accordance with the invention, the circulation of water through the vapor-liquid eductor 16 can be predetermined and monitored/controlled to maintain a desired level or concentration of acrolein. In certain embodiments, the water stream in the vapor-liquid eductor 16 is provided such that the active acrolein concentration in the water stream is about 1.5% or less In general, the maximum endpoint of the range of acrolein concentration is determined based on precluding acrolein polymerization. In certain embodiments, acrolein polymerization occurs if its concentration in water exceeds 4% by weight and therefore, the active acrolein concentration is limited to 4% by weight or less.

Without intending to be bound by any particular theory, it is believed that a novel aspect of the invention is the ability to produce acetal and then provide a quench to produce a dilute, e.g., 1.5% or less, solution of acrolein in a water stream. In certain embodiments, the dilute acrolein-water stream is then directed into a larger stream of water so as to provide an appropriate dose of acrolein to reduce sulfides in the water. In certain other embodiments, the dilute acrolein-water stream is then directed downhole to remove deposits of sulfide on downhole equipment and, oil and gas producing formation.

As described herein, known acrolein-related water treatment processes produce acrolein in high concentration, i.e., pure or essentially pure acrolein. In contrast, the system and process in accordance with the invention produces an acrolein-rich, dilute glycerol-acetal compound rather than pure acrolein. The addition of the glycerol acetal into produced or irrigation water containing an acidic characteristic releases the glycerol and hydrolyzes the acetal essentially immediately, reacting with sulfides in the produced water stream. The produced water stream is directed back into the main water flow where the removal of sulfides continues. In certain embodiments, wherein the treatment stream of the invention is used as an aquatic herbicide, the release of the acetal into a body of water as a quench immediately produces a herbicidal action toward an infestation of algae and/or aquatic plants.

The dehydration step may be carried out in the gas phase or in the liquid phase, preferably, the gas phase. When the dehydration reaction is carried out in the gas phase, various process technologies may be used, such as, a fixed bed process, with one or several reactors in parallel, fluid bed process or a circulating fluid bed process. Reactors of the plate heat exchanger type can also be used. The glycerol dehydration reaction is generally carried out over solid catalyst. As previously described herein, suitable catalysts include homogeneous or heterogenous substances that are insoluble in the reaction medium and which have a Hammett acidity, denoted Ho, of less than +2. The catalyst will be chose among suitable catalysts.

In certain embodiments, the glycerol, or the mixture of glycerol and water introduced into the reactor has a weight ratio which can vary within wide limits, for example from about 0.1 to about 100, and preferably, between about 0.5 and about 4. The mixture of glycerol and water may be used in liquid form or in gaseous form. According to certain embodiments of the invention, greater than about 95% pure glycerol, that is, with less than about 5% water, is employed. The glycerol is blended with a gas mixture including vaporized water and inert gas, for example, from a recycle gas, such that the reaction of converting glycerol into acrolein is conducted in gas phase. Preferably, this step is carried out in the presence of oxygen, or an oxygen-containing gas. The molar ratio of molecular oxygen to glycerol is about 0.1 to 1.5 and, preferably, about 0.5 to about 1.0. The process according to the invention can be carried out in the presence of oxygen, or an oxygen-containing gas, such as, air. Generally, oxygen is present in the gas mixture, but additional oxygen may be injected if the oxygen concentration is too low. The concentration of water of the acrolein-rich stream may vary largely. Water content is from about 3 to about 90% (mol) and, preferably, from about 8 to about 80% (mol).

The acrolein stream then is introduced, e.g., injected, into the water to be treated. In certain embodiments, the water is pumped through a water pump by means of a pressure rising pump. The negative pressure zone of the water pump is connected hydraulically through a control valve to a treatment container box which does not contain any stationary interior installations but contains only separate supply ports for supplying crude acrolein stream acid and hydrolysis water from outside. This simple construction, provides reliable treatment of water with an impure diluted stream of acrolein. The formed aqueous solution of acrolein and impurities is not poisonous and can be safely handled.

In the device of the invention for treating water with acrolein, there is a single control valve in the connecting conduit between the reaction vessel and the box reduced pressure zone. The water pump can control the concentration of acrolein containing material. According to an embodiment of the invention, the control valve is a security valve with adjustable opening pressure whereby it is ensured that the acrolein flows to the negative pressure zone only in case the pressure rising pump is working.

According to an embodiment of the invention, the supply port for supplying the water to be treated into the box is an inhibiting water flow against discharge of acrolein-containing reaction mixture which is arranged as far as possible away from the vessel discharge conduit. No resin formation occurs from the aqueous acrolein produced because there are no stationary interior installations.

In general, the systems and methods of the invention generate a complex mixture composed of solid particulate material in the form of carbon particles and/or coke deposits and, over a period of time, the catalyst activity can be reduced due to plugging of the catalyst pores with coke in the reactor vessel, e.g., the fixed-bed catalyst reactor. The catalyst can be regenerated through oxidizing the coke and removing it as gas including nitrogen, water, carbon monoxide and carbon dioxide. The amount of oxygen is controlled by nitrogen gas dilution in order to control the rise in temperature due to the oxidation of carbon and residual organics, and to protect the integrity of the catalyst by limiting the level of temperature rise during the regeneration process.

In certain embodiments, the reactors can be periodically regenerated over a run-time interval of about 6 to 8 hours and therefore, the process flow is diverted or can alternate, e.g., swing, between the reactors on a frequent basis, e.g., from one reactor to another reactor 3 to 5 times per 24-hour operating period. One method of restoring the performance of the catalyst includes regeneration achieved by introducing air at an appropriate temperature, which is defined as being above the combustion temperature of the particulate matter, thereby burning away the collected particulate matter. The method can also be configured to regenerate the catalyst as an optional after-reaction process, wherein the catalyst is regenerated in place during a non-operation period or removed from the reactor and transferred to a separate regeneration vessel.

Swing reactor systems are known for use in the processing industry for those processes that include frequent regeneration of catalyst, such as, fixed bed reactors, wherein the catalyst is regenerated in-situ and the process swings over to a second or third reactor, while the catalyst in the first reactor is regenerated. A typical regeneration consists of removing the carbon and coke deposits that accumulate over the time the reactor is on stream.

An aspect of the invention relates to a regeneration system and, more particularly, to a regeneration system that reactivates catalyst in a reactor post glycerol-water reaction. In certain embodiments, the regeneration of a catalyst is directed to a catalyst in a fixed bed that remains in the reactor. The regeneration system may include a source of intake air and a method of regenerating the catalyst can include running a heated nitrogen rich (oxygen lean) gas, such as, air, over the catalyst to burn off the carbon and residual organics deposited on the catalyst.

The above described, portable device for treating water with acrolein provides one or more of the following technical advantageous.

Produced acrolein of any concentration can be directly used with the device of the invention without the need for pre-mixture with a solvent or gas. It is particularly advantageous when the treated water supply system can be used for supplying the water for the hydrolysis, whereby additional dosage pumps and control devices are unnecessary. Further, the supply of water with a fixed supply rate into the device irrespective of the operational state thereof is an additional security measure against inadvertent operation or breakdown of the current supply.

The reaction products are stable and they do not regenerate hydrogen sulfide at a later point in the process. The reaction products of the described process are water soluble and do not result in solids formation that cause disposal issues or operational problems downstream of the injection point.

Pure acrolein is not present at any location within the device which means additional security against occurrence of dangerous operation states. A safe operation of the devices is also ensured upon varying or interrupted supply of water.

The avoidance of exposure of workers to concentrated acrolein providing a safer working environment while at the same time effectively removing sulfide from produced fluids and controlling algae and/or aquatic plants from irrigation piping and channels.

### EXAMPLES

### Example 1

An aqueous glycerol solution with 40 wt % glycerol was fed through a pump at a fixed rate of 0.43 ml/min. The solution was preheated to 232° C. (450° F.) in a box oven. The preheated outlet was directed to a vertical standing tube furnace. The tube furnace heating zone length was approximately 18 inches. A temperature controller with a set point of 300° C. (572° F.) was used to control the tube furnace temperature conditions. A stainless steel tube with a minimum inside diameter of 0.5 inch was placed in the tube furnace. The top portion of the tube furnace (12 inch) was packed with an inert packing material to superheat the glycerol solution to 300° C. (572° F.). The bottom portion was packed with a ZSM-5 zeolite catalyst, ground to a particle size of 0.5 to 1.0 mm (5 inch in height) to perform the glycerol dehydration reaction in the gas phase at atmospheric pressure. This bed was maintained at the reaction temperature for 5 to 10 minutes before introducing the aqueous glycerol solution along with nitrogen at a flow rate of 0.8 l/h. The duration of each test was approximately 8 hours. After reaction, the products were condensed in a trap refrigerated with crushed ice. Samples of the liquid effluent were collected periodically. These were analyzed for acrolein concentration on a HP6890 chromatograph equipped with a mass spectral detector. The reaction temperature, gas hourly space velocity, mass of catalyst along with results are presented in Table 1 below.

TABLE 1

| | | Resi- | | | | Acrolein |
|---|---|---|---|---|---|---|
| | | dence | Mass of | | Acrolein | Produc- |
| Temp | GHSV | Time | Catalyst | Glycerol | Yield | tivity |
| (° C.) | (hr⁻¹) | (sec) | (g) | Conv.(%) | (%) | (ml/g_{cat} hr) |
| 300 | 574 | 6.3 | 12 | 100 | 35 | 0.24 |
| 300 | 1148 | 3.1 | 6 | 90.01 | 36 | 0.50 |
| 300 | 2296 | 1.6 | 6 | 98 | 40 | 0.55 |
| 300¹ | 2431 | 1.5 | 6 | 100 | 43 | 0.28 |
| 300² | 2583 | 1.4 | 6 | 86.67 | 35 | 0.48 |
| 300³ | 2755 | 1.3 | 6 | 95.64 | 32 | 0.43 |
| 300⁴ | 2296 | 1.6 | 6 | 99.67 | 18 | 0.24 |
| 320 | 2755 | 1.6 | 6 | 97.28 | 22 | 0.30 |

¹Glycerol concentration 20 wt %
²Zeolite Beta Catalyst
³Run time: 7 hrs
⁴Glycerol concentration 30 wt %

### Example 2

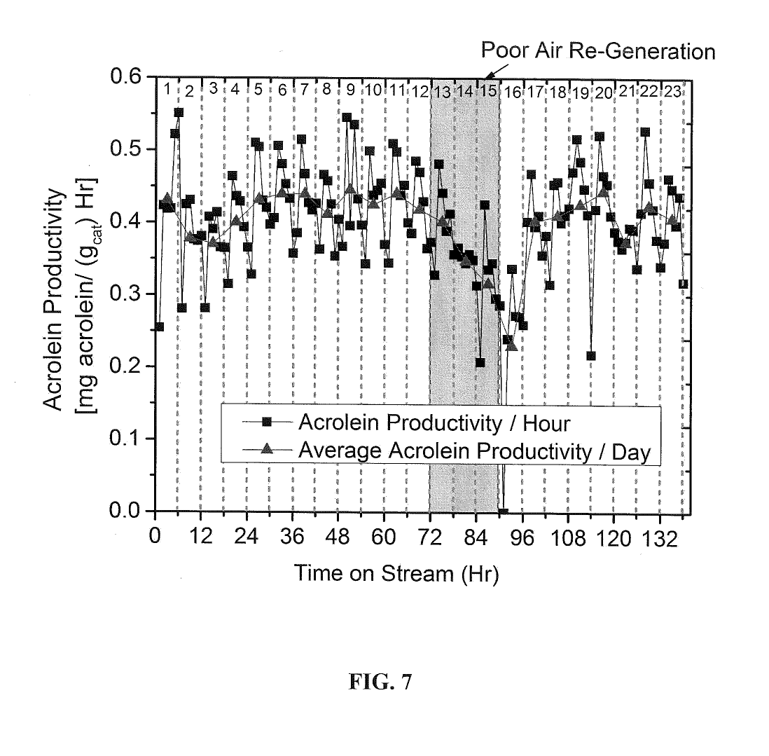

In a second series of experiments, Example 1 was repeated with 6 g of HZSM-5 catalyst, wherein at the end of each experiment the catalyst bed was regenerated for an hour with air flowing at 350 cc/min. During regeneration, the tube furnace temperature was set to 500° C. FIG. 7 shows acrolein productivity per hour and average acrolein productivity observed per day for a period of 23 days. Each day the experiment was carried out for 6 hours.

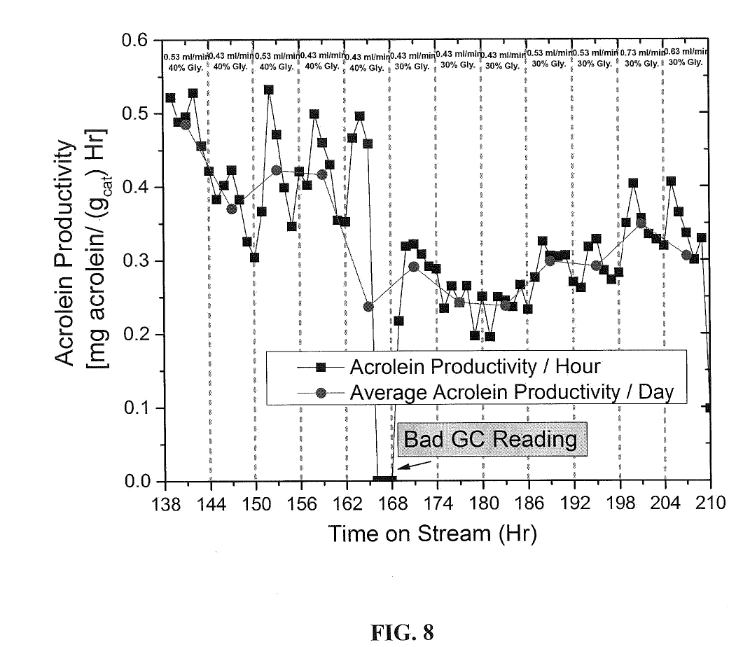

The experiment continued with the same catalyst for another 12 days to study the sensitivity of the reaction for different concentrations of glycerol in water and various flow rates through the catalyst bed. FIG. 8 shows the acrolein productivity per hour and average acrolein productivity observed per day for a period of 12 days.

During 35 days of experimentation, the catalyst was shown to regain its activity after regenerating with air.

### Example 3

100 ml of 2:1, 3:1 and 4:1 molar ratio of crude acrolein produced as above or commercial acrolein to sulfide were prepared. The pH of each of the solutions was approximately 8.0 (without any need for additional adjustment of pH). Aliquots were taken out at separate time intervals and concentrations of sulfide were measured by HACH methylene blue method. The entire experiment was performed anaerobically. The rate of sulfide removal was compared between commercial acrolein and acrolein produced in accordance with the invention. The sulfide content of the control was measured at equal time intervals, where the control had no acrolein in it. Tables 2, 3 and 4 show the rate of percentage removal of sulfides comparing commercial acrolein and acrolein produced in accordance with the invention at 2:1, 3:1 and 4:1 molar ratios, respectively.

TABLE 2

| Time (Minutes) | 2:1 Acrolein:Sulfide | 2:1 AcroGen ™:Sulfide |
|---|---|---|
| 15 | 98.4% | 98.9% |
| 30 | 99.85% | 99.8% |
| 45 | 100.0% | 99.95% |
| 60 | 100.0% | 99.95% |

TABLE 3

| Time (Minutes) | 3:1 Acrolein:Sulfide | 3:1 AcroGen ™:Sulfide |
|---|---|---|
| 5 | 97.7% | 98.82% |
| 10 | 99.37% | 99.55% |
| 15 | 99.75% | 99.67% |
| 20 | 100.0% | 99.90% |
| 25 | 100.0% | 99.95% |
| 30 | 100.0% | 99.95% |

TABLE 4

| Time (Minutes) | 4:1 Acrolein:Sulfide | 4:1 AcroGen ™:Sulfide |
|---|---|---|
| 1 | 96.95% | |
| 3 | 98.2% | 99.95% |
| 6 | 99.5% | |
| 9 | 99.9% | |
| 12 | 100.0% | |
| 15 | 100.0% | |

As demonstrated, the acrolein system and process in accordance with the invention generated acrolein (containing impurities and acetal) required 1 hour to scavenge sulfides completely in a ratio of 1 hydrogen sulfide to 2 acrolein molecules. For a 3:1 molar ratio, sulfide was completely removed in 25 minutes. For a 4:1 molar ratio, sulfide was completely removed in less than 3 minutes. These results compare very favorably with commercially produced acrolein, for which the 2:1 molar ratio required 45 minutes to scavenge sulfides completely; for the 3:1 molar ratio, sulfide was completely removed in 25 minutes; and for the 4:1 molar ratio, sulfide was completely removed in 12 minutes.

Additional objects, advantages and novel features of the invention may become apparent to one of ordinary skill in the art based on the above description and examples, which are provided for illustrative purposes and are not intended to be limiting.

1. An on-site method of treating a volume, stream or body of water, comprising:
producing an acrolein-containing stream having a concentration of acrolein that is less than pure or substantially pure acrolein, wherein said stream is produced on-site and outside of the volume, stream or the body of water;
introducing the acrolein-containing stream into the volume, stream or the body of water,
wherein, the acrolein-containing stream is effective to reduce or remove sulfide therefrom.

2. The method of claim 1, wherein the acrolein-containing stream is derived from a process selected from the group consisting of catalytic oxidation and catalytic glycerol dehydration.

3. The method of claim 1, wherein the acrolein-containing stream includes materials selected from the group consisting of water, oxygen, catalyst, by-products and mixtures thereof.

4. The method of claim 3, wherein the by-products include materials selected from the group consisting of hydroxypropanone, acetaldehyde, acetone, addition products of acrolein to glycerol, polycondensation products of glycerol, cyclic glycerol ethers, hydroxypropenal, phenol, polyaromatic compounds, propylene, acrylic acid, carbon dioxide, nitrogen, helium, argon, propane and mixtures thereof.

5. A method for treating a volume, stream or body of water, comprising:
providing a water feed;
providing a glycerin feed;
mixing the water feed and glycerin feed to produce a water-glycerin solution;
heating the water-glycerin mixture to produce a water-glycerin vapor;
reacting the water-glycerin vapor with catalyst in a reactor to produce a glycerol stream;
introducing the glycerol stream into the water to be treated.

6. The method of claim 5, wherein the glycerol is effective to generate acrolein when in contact with the water to be treated.

7. The method of claim 5, wherein the reactor is a fixed-bed catalyst reactor.

8. The method of claim 5, wherein the glycerin is derived from vegetable oil or animal fat.

9. A portable system for treating a volume of water, comprising:
a feed mechanism for supplying glycerin;
a feed mechanism for supplying water;
a vessel for receiving and mixing the glycerin and water to form a glycerin/water blend;
a heating system to vaporize the glycerin/water blend to form a glycerin/water vapor stream;
a reactor to convert the glycerin/water vapor stream into an acetal-containing material, wherein said reactor is positioned directly or nearly directly upstream of the volume of water to be treated;
a side stream containing water from the volume of water to be treated; and
a delivery mechanism to introduce the acetal-containing material into the side stream to generate acrolein,
wherein the water with the acrolein in the side stream flows into the volume of water to be treated.

10. The system of claim 9, wherein the reactor is a fixed-bed catalyst reactor.

11. The system of claim 9, wherein the water to be treated is produced water from an oil field or gas field.

12. The system of claim 9, wherein the water to be treated contains sulfide.
